(19) United States
(12) Patent Application Publication
(10) Pub. No.: US 2005/0125269 A1
(43) Pub. Date: Jun. 9, 2005

(54) Information security and resource optimization for workflows

(76) Inventors: Vishal Singh Batra, Noida (IN); Amit Anil Nanavati, New Delhi (IN); Biplav Srivastava, Noida (IN)

Correspondence Address: Frederick W. Gibb, III;McGinn & Gibb, PLLC, Suite 304, 2568-A Riva Road, Annapolis, MD, 21401, US

(21) Appl. No.: 10/729,814

(22) Filed: Dec. 5, 2003

(51) Int. Cl. G06F 17/60

(52) U.S. Cl. 705/7

(57) ABSTRACT

Workflows are constructed to minimize a cost function that can be representative of information exposure risk and resource overhead. Given a workflow specification that defines a predetermined input and a required output, a set of possible workflows that meet this workflow specification can be constructed. The possible workflows are constructed using components that have defined inputs and outputs. A set of possible workflows results, and an exposure measure is calculated for each of these possible workflows. A workflow that has a minimum calculated exposure measure is selected and returned.

### FIELD OF THE INVENTION

The present invention relates to information security and resource optimization for workflows.

### BACKGROUND

Consider a workflow in which a component C generates output based on the intermediate output generated by an ancestor component P. FIG. 1 illustrates this simple example.

Information “b” is produced by component X and consumed by component Y. Information “c” is also produced by component X and consumed by component Y. Information “d” is produced by component X. Information “f” is produced by component Y and consumed by component Z. Information “x” is produced by component Z. These relationships are also presented in tabular form in Table 1 below.

TABLE 1

b: X (producer), Y (consumer)
c: X (producer), Y (consumer)
d: X (producer)
f: Y (producer), Z (consumer)
x: Z (producer)

Thus P is defined as a producer of information and C is defined as P's consumer. In this case, the distance between a producer (P) and its consumer (C) may be large, which results in increased message size and related overheads, message compression, message re-routing, message breakup and re-assembly, information exposure to other components, encryption, region locking, etc.

Consider a set of components S with defined input/output specifications. The problem of constructing a workflow that takes I as the input and generates O as output using components from the set S in accordance with the “minimal exposure maxim”, namely, “as far as possible, the distance between the producer and consumer is minimised, and so are the number of redundant inputs to any component”.

Such an approach minimises the overheads of encryption, locks, message compression, and so on. Planning is a sub-field of Artificial Intelligence (AI) that concerns how to automatically generate plans (workflows) based on component descriptions. Various optimization criteria can be used, such as “number of steps in the plan” but existing work does not take into account information flow security, and resource optimization on workflow nodes.

A need exists in view of these existing practices and publications of providing an improved manner of managing workflows.

### SUMMARY

The approach to information security and resource optimization described herein introduces the notion of “minimal exposure” as an advance over existing paradigms. Workflows are constructed to minimize a cost function that can be representative of information exposure risk and resource overhead. Minimizing information exposure risk provides enhanced information security. Message transmission, compression, encryption, locking and related overheads may also be reduced. The notion of an exposure measure is introduced to quantify the way in which exposure risk is reduced.

As an example, the exposure measure may be calculated based upon the amount of information that is exposed, or the duration for which that information is exposed, or a combination of both. A variety of other exposure measures may be formulated to meet particular requirements.

Given a workflow specification that defines a predetermined input and a required output, a set of possible workflows that meet this workflow specification can be constructed. The possible workflows are constructed using components that have defined inputs and outputs. A set of possible workflows results, and an exposure measure is calculated for each of these possible workflows. A workflow that has a minimum calculated exposure measure is selected and returned.

### DESCRIPTION OF DRAWINGS

FIG. 1 is a schematic representation of an example workflow used to illustrate existing techniques.

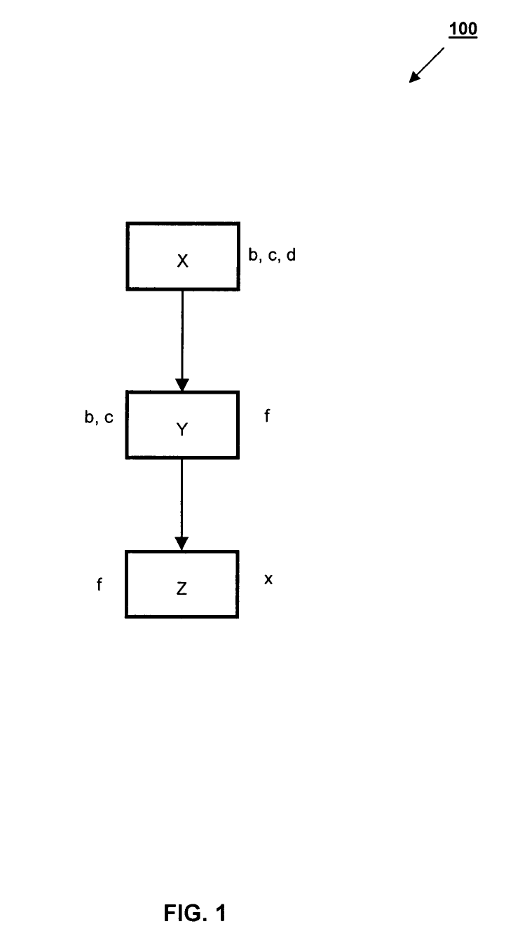

FIG. 2 is a schematic representation of components from which workflows are designed in the examples of FIG. 3.

FIG. 3 is a schematic representation of first and second possible workflows.

FIG. 4 is a schematic representation of two possible workflows in a travel services context.

FIG. 5 is a schematic representation of components from which workflows are designed in the example of FIG. 6.

FIG. 6 is a schematic representation of a system for deploying text-mining applications

FIG. 7 is a flow chart of steps involved in the resource optimization of workflows.

FIG. 8 is a schematic representation of a computer system suitable for performing the techniques described herein.

### DETAILED DESCRIPTION

Workflows are desirably managed to minimize any unnecessary information exposure, and to optimize the resources consumed for executing the workflow. The approach described herein addresses limitations to constructing workflows concerning security risk. minimisation of storage, number of synchronisation points, encryption/decryption overheads, number of messages, and message compression overheads.

### General Example

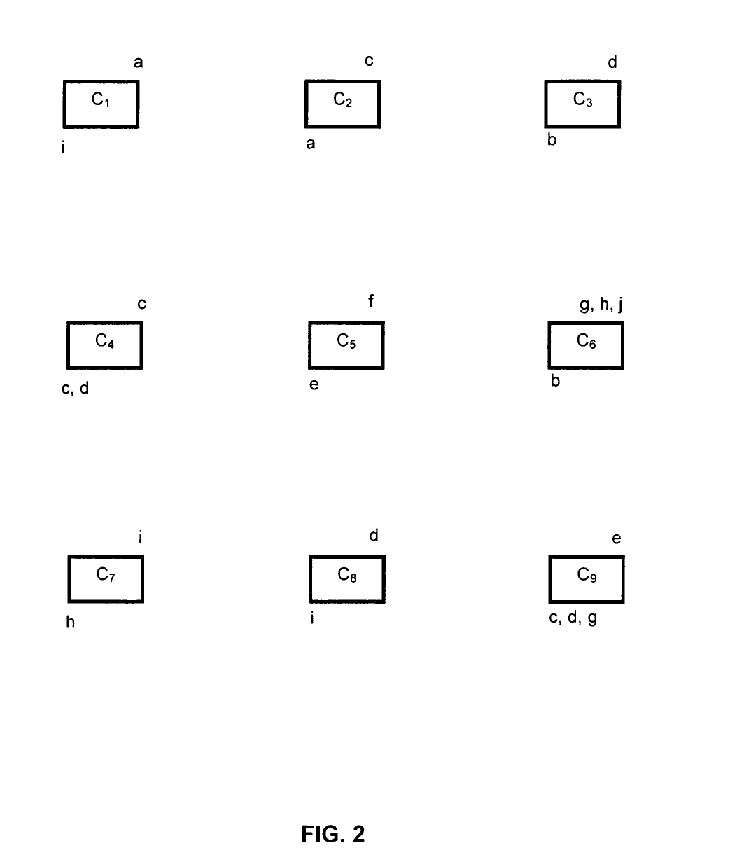

FIG. 2 represents available components C₁ to C₉ from which workflows can be constructed in a particular example. An input (or precondition) for each component C₁ to C₉ is indicated by the letter positioned at the lower left corner of the component. The output (or effect) of each component C₁ to C₉ is indicated by the letter positioned at the upper right corner of the component. Each of these letters of the alphabet shown in FIG. 2 (from a to j) represents a unit of information. Thus, the defined input for C₁ is i. and the defined output for C₁ is a.

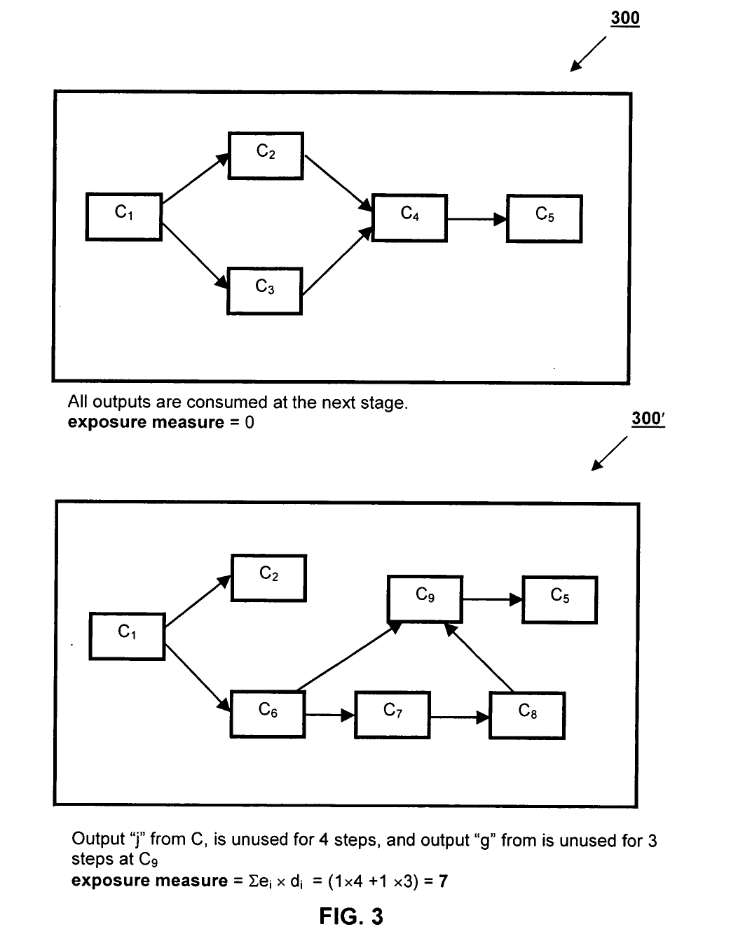

Workflows are constructed based upon a workflow specification that has a null input as a predetermined input, and information unit f as a required output. Two possible workflows that achieve this goal are shown in FIG. 3 as alternative workflows 300 and 300′.

The first workflow 300 has no exposure, as any information that is produced is consumed by the very next stage. This can also be thought of as “just-in-time” production of inputs for the next stage. Exposure is avoided as information that is produced at any stage is consumed by the very next stage. There is no stage at which an information unit that is available is not used.

The second workflow 300′ produces information (“j”) that is unused for 4 steps while other information (“g”) is stored for 3 steps. Security and resource overhead implications consequently exist. If “j” is critical, then “j” can be protected in some manner, such as by encryption. Information “g”, by contrast, can be stored in a buffer at C₉ for synchronisation, which is a resource overhead. If information is unnecessarily stored at a component because the component cannot proceed with processing without such information being present, the storage of already available information constitutes a resource overhead, in this case memory storage.

Composing different workflows involves considering all choices of cascading individual components (that is, workflow choices) that lead us from the initial input to the final output. Given the component specifications, which define the input and output specification of each component, the initial input and the desired final output of the workflow specification can be achieved, usually by different possible workflows. To choose from the candidates workflows, one evaluates each candidate workflow based on an exposure measure.

The set of all workflows is considered. That is, the search space of all possible ways of cascading workflows is searched using planning techniques. Planning techniques are a field of Artificial Intelligence (AI) that has developed techniques to synthesize plans based on description of a formal domain theory and a goal that has to be achieved. A brief description is provided, though further information about planning problems is available in a publication by Daniel S. Weld, “Recent Advances in AI Planning”. AI Magazine, Volume 20, No. 2, 1999, pp 93-123. The content of this reference is hereby incorporated by reference.

First, some terminology is defined. An object is an entity represented by terms (constants or variables) in a domain. A predicate is a logical construct that refers to the relationship between objects in the domain. A state T is simply a collection of facts with the semantics that information corresponding to the predicates in the state holds (that is, is true). An action A_i is applicable in a state T if the precondition of A_i is satisfied in T and the resulting state T′ is obtained by incorporating the effects of A_i. An action sequence S (a plan) is a solution to P if S can be executed from I and the resulting state of the world contains G.

A planning problem P is a 3-tuple <I, G, A>, in which I is the complete description of the initial state, G is the partial description of the goal state, and A is the set of executable (primitive) actions.

To create plans for composing workflows, software components are modelled as actions. Thus, information about a software component, including its inputs (preconditions or dependencies) and outputs (effects or functionalities) is represented by predicates. Given a specification of a goal, one can formulate a planning problem and solve the problem using existing algorithms. One such algorithm is provided in the reference entitled “Recent Advances in AI Planning”, mentioned above. A suitable workflow that minimises the exposure measure is selected. If a minimal workflow cannot be determined (due to computational or specificational restrictions), one can apply heuristic, probabilistic or approximation approaches to find a suitable solution.

An exposure measure is predetermined, and can be based upon (i) an “exposure number” (e), and (ii) an “exposure duration” (d). The “exposure number” may be a number of information units exposed. The “exposure duration” may be the units of time for which information units are exposed or stored. A few example exposure measures are tabulated in Table 2 below with accompanying observations.

TABLE 2

| | |
|---|---|
| e × d | The number of information units exposed is as critical as the |
| | duration of exposure. |
| e² × d^{1/2} | The number of information units exposed is more critical than |
| | the duration of exposure. Fewer information units are exposed, |
| | even if for a longer duration. |
| Σᵢeᵢdᵢ | The term eᵢ denotes the exposure number of information unit “i”, |
| | and dᵢ denotes its duration. Each information unit may not be |
| | equally sensitive. |

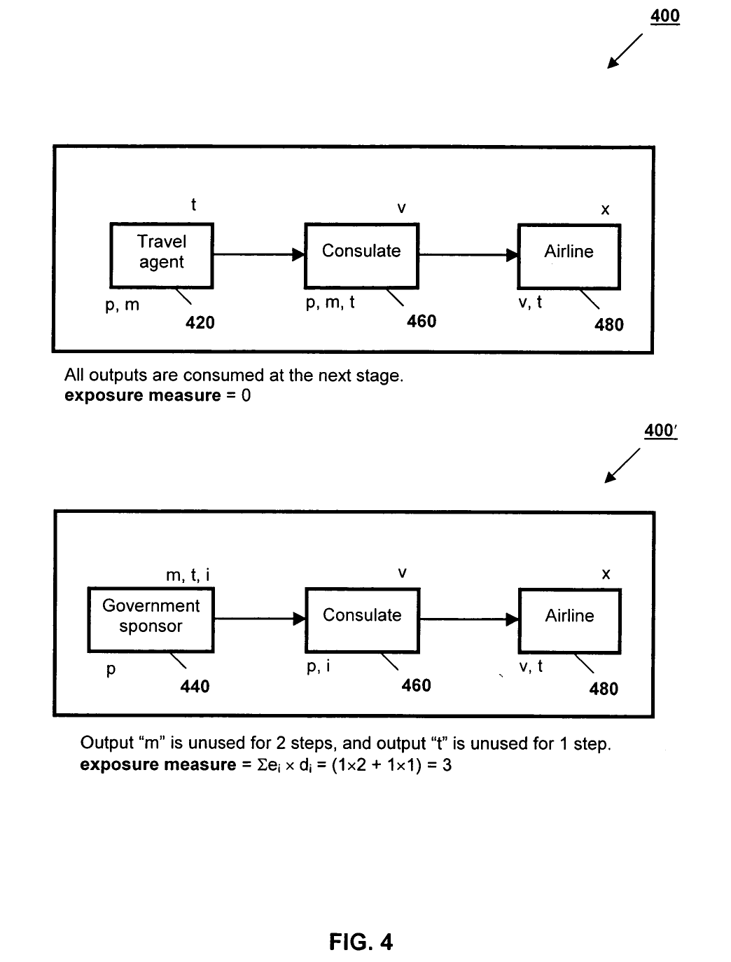

The exposure measure, however formulated, is calculated for each possible workflow. As the exposure measure is a cost function to be minimised. The possible workflow that has a minimum calculated exposure measure can be selected as a candidate for subsequent use. In the examples that follow (FIGS. 3 and 4), an exposure measure having the formula Σeᵢdᵢ is used.

Example—Travel Services

FIG. 4 represents these two alternative plans 400 and 400′ for an example relating to travel requirements. First plan 400 involves a travel agent 420, consulate 460, and airline 480, whereas second plan 400′ instead involves government sponsor 440, consulate 460, and airline 480. This example may be implemented by integrating different business processes using web services. In FIG. 4, p represents “passport”, m represents “money”, t represents “ticket”, i represents “itinerary”, v represents “visa”, and x represents “flight”, the final objective. For each step in the plans 400 and 400′, the input is represented at the bottom left of the respective blocks, and the output represented at the top right of the respective blocks.

First plan 400 has no unnecessary exposure of information. What is produced at any stage is consumed by the very next stage. Second plan 400′ proposes that the “tickets” and “money” are unnecessarily exposed, or requires security measures for protecting this information. The first plan 400 requires no such security measures, and hence may be favoured over the second plan 400′ from a resource overhead as well as a security perspective.

Example—Text-mining Application

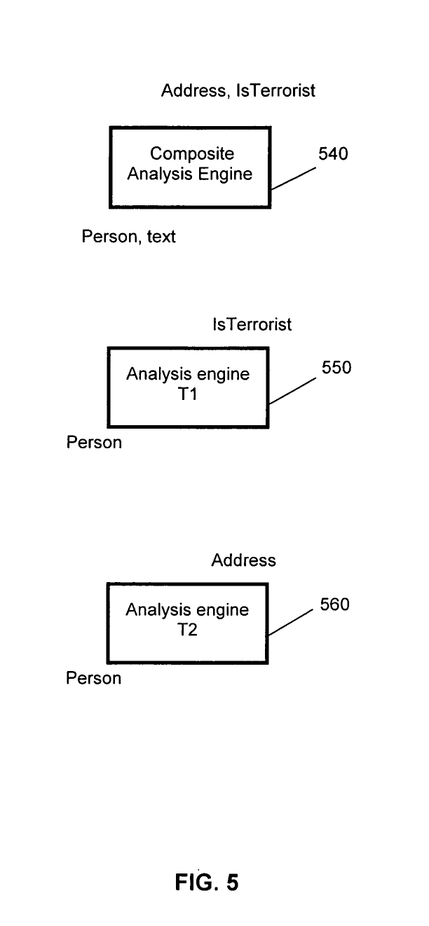

FIG. 5 schematically represents components 540, 550, 560 that are Analysis Engines (AEs) used in the text-mining application described below. This text-mining application is described to illustrate an analysis of information exposure in a particular application.

Each represented AE 540, 550, 560 has inputs indicated at the lower left corner of the component, and outputs indicated at the upper right of each component. The input and output of the AEs 540, 550, 560 is formatted in accordance with a predetermined Annotation Structure (AS) that encapsulates the text mining results (annotations).

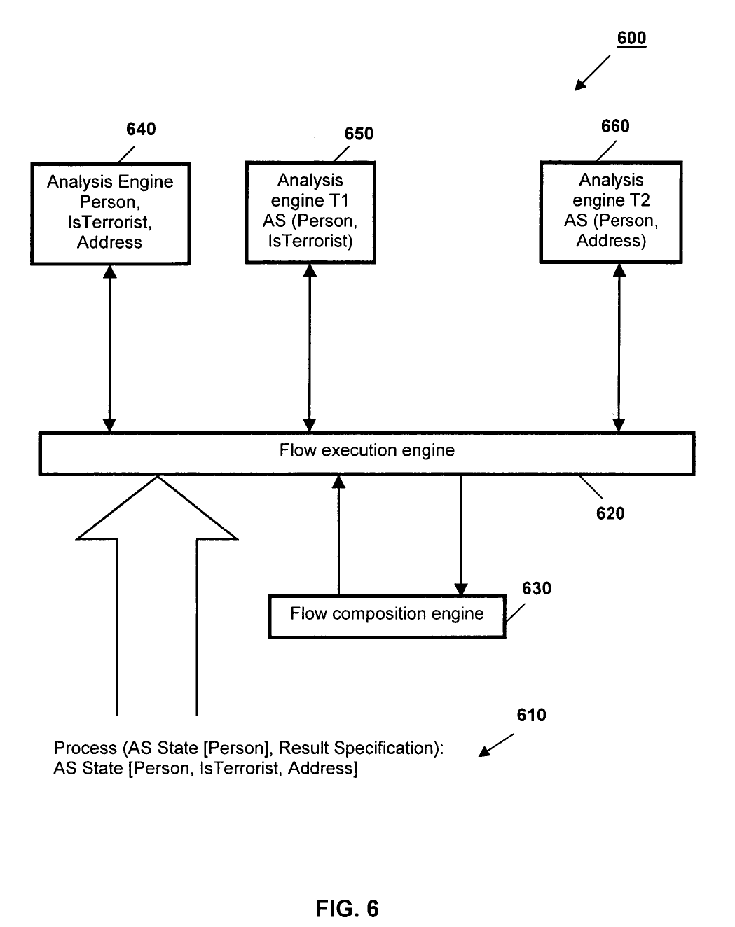

FIG. 6 schematically represents an architecture of a composite analysis engine 600 that uses delegate analysis engines T1 and T2 650, 660. Components 540, 550 and 560 in FIG. 5 correspond to 640, 650 and 660 of FIG. 6 respectively. The composite analysis engine 600 takes “Person” annotation and text 610 as input, and generates “Address” and “IsTerrorist” annotations as output.

Text analysis architecture represented in FIG. 6 provides support for integrating text-mining applications in a workflow to allow composite analysis. Disparate applications deployed remotely can be integrated using a common data exchange model.

This common data exchange model is AS (Annotation Structure). AS holds the results of text analysis that is, annotations etc. produced by the text-analysis applications. In an integrated analysis scenario, AS is passed among applications on a given workflow to allow each application build (analyze) on top of the results (annotations) of previous application in the workflow.

To make the information (annotations) flow secure and efficient, the flow execution engine passes (copies) only the relevant AS state to the next application in the workflow. Thus AS on each application is configured for specific annotations that the application may use (that is, annotations the application can receive and produce following analysis). A flow manager segments the state of AS that needs to be “forwarded” in the flow using the target AS configuration information.

Delegate analysis engines T1 and T2 650, 660 take “Person” as an input and generate “IsTerrorist” and “Address” annotations as outputs respectively. The flow execution engine 620 invokes analysis engines T1 and T2 650, 660 in a sequence, passing only required annotations (information), namely the “Person” annotation.

The AS of analysis engines T1 and T2 650, 660 is configured to load only desired annotations only (namely “Person” and “IsTerrorist” annotations on T1 650 and “Person” and “Address” annotations on T2 660). The flow execution engine 620, using this configuration information, does not pass the “IsTerrorist” annotation to T2 660, which is produced by T1 650, as this may expose any confidential information.

The composite analysis engine 600 allows dynamic workflows by lacing text-analysis applications based on the input of result specification (that is, required annotations in the final composite analysis result), and the AS specification of each of the text-analysis application.

This dynamic workflow generation may lead to more than one workflow paths, and thus the flow composition engine 630 is used to choose the most effective and desirable workflow, which may have least resource overhead (for scalability), minimal exposure (for security), and least network traffic (for performance). A suitable exposure measure can be adopted as required to determine a suitable workflow path in each case.

Procedural Overview

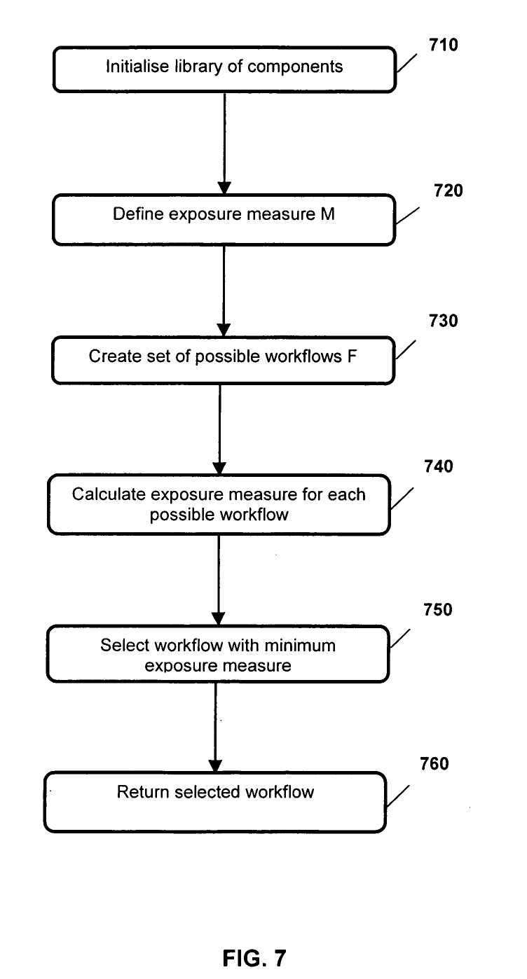

FIG. 7 is a flowchart of steps involved in optimizing workflows. Table 3 presents these steps using corresponding reference numbering for the steps indicated in FIG. 7.

TABLE 3

| | |
|---|---|
| Step 710 | Intialization a library of components with input and output |
| | specification |
| Step 720 | Define an exposure measure, M. |
| Step 730 | Create possible workflows F based on initial input I and |
| | desired output G. |
| Step 740 | Calculate M(f) for each possible workflow “f” in F. |
| Step 750 | Select workflow “g” such that M(g) is minimum. |
| Step 760 | Return “g” as favoured workflow. |

A library of components is first initialized in step 710. An exposure measure M is defined in step 720. A set of possible workflows is then created in step 730. These possible workflows meet the workflow specification of the task to be performed. The workflow specification defines an initial input I, and a desired final output G. An exposure measure is then calculated in step 740 for each of the possible workflows. The exposure measure follows a predetermined expression, and can be selected or modified as required. The workflow that has the minimum calculated exposure measure is selected in step 750, and returned in step 760.

Computer Hardware And Software

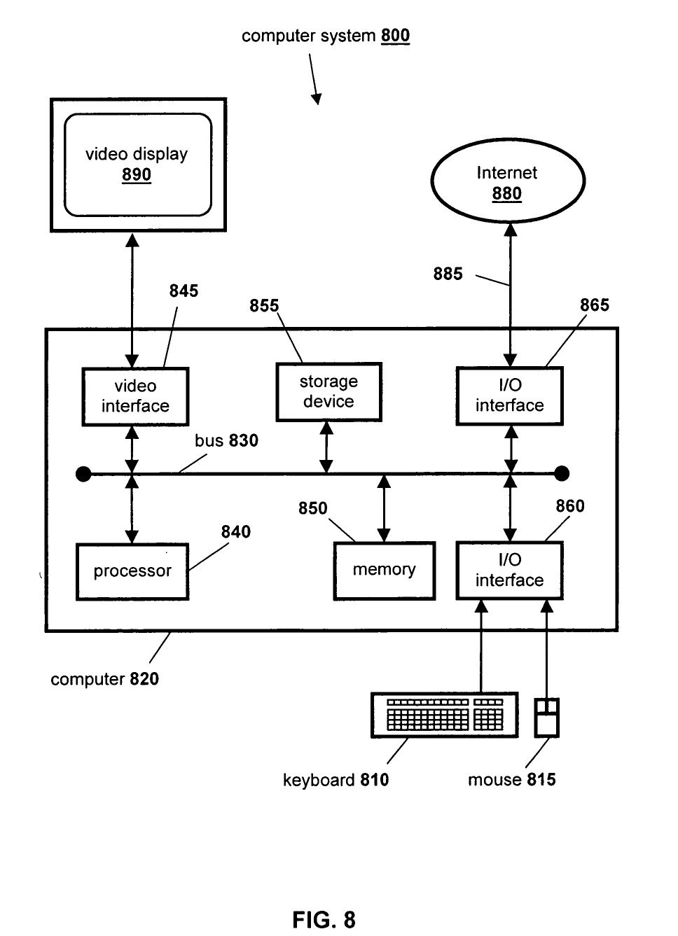

FIG. 8 is a schematic representation of a computer system 800 that is suitable for performing analysis of the type described herein. Computer software executes under a suitable operating system installed on the computer system 800 to assist in performing the described techniques. This computer software is programmed using any suitable computer programming language, and may be thought of as comprising various software code means for achieving particular steps.

The components of the computer system 800 include a computer 820, a keyboard 810 and mouse 815, and a video display 890. The computer 820 includes a processor 840, a memory 850, input/output (I/O) interfaces 860, 865, a video interface 845, and a storage device 855.

The processor 840 is a central processing unit (CPU) that executes the operating system and the computer software executing under the operating system. The memory 850 includes random access memory (RAM) and read-only memory (ROM), and is used under direction of the processor 840.

The video interface 845 is connected to video display 890 and provides video signals for display on the video display 890. User input to operate the computer 820 is provided from the keyboard 810 and mouse 815. The storage device 855 can include a disk drive or any other suitable storage medium.

Each of the components of the computer 820 is connected to an internal bus 830 that includes data, address, and control buses, to allow components of the computer 820 to communicate with each other via the bus 830.

The computer system 800 can be connected to one or more other similar computers via a input/output (I/O) interface 865 using a communication channel 885 to a network, represented as the Internet 880.

The computer software may be recorded on a portable storage medium, in which case, the computer software program is accessed by the computer system 800 from the storage device 855. Alternatively, the computer software can be accessed directly from the

Internet 880 by the computer 820. In either case, a user can interact with the computer system 800 using the keyboard 810 and mouse 815 to operate the programmed computer software executing on the computer 820.

Other configurations or types of computer systems can be equally well used to implement the described techniques. The computer system 800 described above is described only as an example of a particular type of system suitable for implementing the described techniques.

Conclusion

Various alterations and modifications can be made to the techniques and arrangements described herein, as would be apparent to one skilled in the relevant art.

1. A method for selecting a workflow, said method comprising the steps of:
constructing a set of possible workflows meeting a workflow specification having a predetermined input aid a required output, using components having defined inputs and outputs;
calculating a predetermined exposure measure for each of the possible workflows in the set of possible workflows; and
selecting the constructed set of possible workflows for which the predetermined exposure measure is calculated to be a minimum.

2. The method as claimed in claim 1, further comprising the step of storing a library of components from which possible workflows can be constructed.

3. The method as claimed in claim 1, further comprising the step of defining an exposure measure to be representative of an amount of information that a constructed workflow exposes.

4. The method as claimed in claim 1, further comprising the step of defining an exposure measure to be representative of a duration for which a constructed workflow exposes information.

5. The method as claimed in claim 1, further comprising the step of defining an exposure measure to be representative of an amount of information that a constructed workflow exposes, and a duration for which information is exposed.

6. A computer system for selecting a work low comprising computer software recorded on a computer-readable medium, said computer system comprising:
means for constructing a set of possible workflows meeting a workflow specification having a predetermined input and a required output, using components having defined inputs and outputs;
means for calculating a predetermined exposure measure for each of the possible workflows in the set of possible workflows; and
means for selecting the constructed set of possible workflows for which the predetermined exposure measure is calculated to be a minimum.

7. A computer program product for selecting a workflow comprising computer software recorded on a computer-readable medium for performing the steps of:
constructing a set of possible workflows meeting a workflow specification having a predetermined input and a required output, using components having defined inputs and outputs;
calculating a predetermined exposure measure for each of the possible workflows in the set of possible workflows; and
selecting the constructed set of possible workflows for which the predetermined exposure measure is calculated to be a minimum.

8. The computer system in claim 6, further comprising means for storing a library of components from which possible workflows can be constructed.

9. The computer system in claim 6, further comprising means for defining an exposure measure to be representative of an amount of information that a constructed workflow exposes.

10. The computer system in claim 6, further comprising means for defining an exposure measure to be representative of a duration for which a constructed workflow exposes information.

11. The computer system in claim 6, further comprising means for defining an exposure measure to be representative of an amount of information that a constructed workflow exposes, and a duration for which information is exposed.

12. The computer program product in claim 7, further comprising the step of storing a library of components from which possible workflows can be constructed.

13. The computer program product in claim 7, further comprising the step of defining an exposure measure to be representative of an amount of information that a constructed workflow exposes.

14. The computer program product in claim 7, further comprising the step of defining an exposure measure to be representative of a duration for which a constructed workflow exposes information.

15. The computer program product in claim 7, further comprising the step of defining an exposure measure to be representative of an amount of information that a constructed workflow exposes, and a duration for which information is exposed.
